(19) United States
(12) Patent Application Publication
(10) Pub. No.: US 2009/0094397 A1
(43) Pub. Date: Apr. 9, 2009

(54) HOST CONTROLLER DEVICE AND DATA TRANSFER CONTROL METHOD

(75) Inventor: Hiroshi KARIYA, Kanagawa (JP)

Correspondence Address: YOUNG & THOMPSON, 209 Madison Street, Suite 500, ALEXANDRIA, VA, 22314, US

(73) Assignee: NEC ELECTRONICS CORPORATION, Kanagawa (JP)

(21) Appl. No.: 12/212,965

(22) Filed: Sep. 18, 2008

(30) Foreign Application Priority Data
Oct. 9, 2007 (JP) 2007-263388

(51) Int. Cl. G06F 13/14

(52) U.S. Cl. 710/305

(57) ABSTRACT

Data transfer efficiency has been unsatisfactorily decreased in host controller devices for USBs because of the fact that they must read out a loop of endpoint information including endpoint information that do not contribute to data transfer in a successive manner. In accordance with one embodiment of the present invention, a host controller device installed in a host device having a system memory 2 to communicate with a USB device includes an information select portion 13 to select endpoint information requesting data transfer by analyzing a plurality of endpoint information held in the system memory 2, a storage area 14 to store at least one address in system memory 2 identifying the selected endpoint information, and a data transfer portion 15 to carry out the requested data transfer based on the endpoint information identified by the at least one address in system memory 2 stored in the storage area 14.

### BACKGROUND OF THE INVENTION

1. Field of the Invention

The present invention relates to a host controller to carry out data transfer with a USB (Universal Serial Bus) device.

2. Description of Related Art

Although the specifications of USB protocol had been established on the assumption that USBs (Universal Serial Buses) would have been used in wired environments, wireless USB techniques that enable the USB to be unwired has been developed in recent years. For example, data transfer with wireless USB devices through wireless communication has been realized by equipping the host device with a driver to control data transfer with wired USB devices and a host controller device for the wireless communication. In USBs, data transfer is carried out based on endpoint information. In such cases, the endpoint information is located in the system memory of the host device. Therefore, the host controller device has to successively read and analyze the endpoint information located in the system memory.

Furthermore, the endpoint information retains the address in system memory of the next endpoint to be referred so that it can designate the next endpoint to be referred. The last endpoint information is configured so as to refer the first endpoint information, so that a plurality of endpoint information form a loop configuration. Therefore, the host controller device refers to all endpoint information in a circular manner by referring to each of the endpoint information in sequence. Alternatively, the last endpoint information may have termination information, so that a plurality of endpoint information form a linear configuration. Even in such a case, a plurality of endpoint information are referred in sequence until the endpoint information having the termination information is referred. Then, subsequent to the endpoint information having the termination information, they are referred again from the first endpoint information so that they are referred in a circular manner. Endpoint information includes endpoint information that request data transfer and endpoint information that do not contribute to data transfer, and they constitute one loop without making any distinction between them. Therefore, when data transfer is to be carried out, the host controller has to select endpoint information that requests data transfer by reading out endpoint information one by one from the system memory.

Japanese Unexamined Patent Application Publication No. 2001-127767 discloses a technique to increase transfer efficiency by reducing access time to the shared memory during queue control in the packet transfer processes of a wireless LAN (Local Area Network). However, this technique was very difficult to apply to the data transfer of wireless USBs.

As described above, since endpoint information includes endpoint information that does not contribute to data transfer, the host controller device cannot carry out data transfer until it reads out endpoint information that contributes to the data transfer. Furthermore, in the case where data transfer is to be requested by more than one endpoint information, the host controller device needs to read out not only the endpoint information that contributes to the data transfer but also endpoint information that does not contribute to the data transfer in order to acquire the endpoint information that is referred subsequent to that endpoint information for every transfer request.

As a result, there has been a problem in host controller devices for USBs that data transfer efficiency has been unsatisfactorily decreased because of the fact that they must read out a loop of endpoint information including endpoint information that do not contribute to data transfer in a successive manner.

### SUMMARY

In accordance with one embodiment of the present invention, a host controller device installed in a host device having a system memory to communicate with a USB device includes: an information select portion to select endpoint information requesting data transfer by analyzing a plurality of endpoint information held in the system memory; a storage area to store at least one address in system memory identifying the endpoint information selected by the information select portion; and a data transfer portion to carry out the requested data transfer based on the endpoint information identified by the at least one address in system memory stored in the storage area.

In this manner, data transfer can be carried out without accessing endpoint information held in the system memory in a successive manner. Therefore, it can reduce the number of accesses to the system memory, and thereby improving the data transfer efficiency.

Furthermore, in accordance with another embodiment of the present invention, a data transfer control method of a host controller device installed in a host device having a system memory to communicate with a USB device includes: reading out a plurality of endpoint information held in the system memory one by one; selecting endpoint information requesting data transfer by analyzing the read-out endpoint information; storing an address in system memory identifying the selected endpoint information in a storage area; repeating the storing step for each of the plurality of endpoint information held in the system memory; and carrying out data transfer based on at least one address in system memory stored in the storage area.

The present invention can eliminate the process of reading out a loop of endpoint information including endpoint information that does not contribute to data transfer in a successive manner in host controller devices for USBs. As a result, it can improve the data transfer efficiency.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 shows an example of the structure of a system to carry out wireless USB communication in accordance with one aspect of the present invention;

FIG. 2 is a block diagram showing an example of the structure of a host controller device in accordance with one embodiment of the present invention;

FIG. 3A is figures for illustrating a read-out process in which endpoint information held in a system memory is read out successively in a circular manner;

FIG. 3B shows the order in which endpoint information is read out;

FIG. 3C shows a state in which only the effective endpoint information is read out;

FIG. 4 is a flowchart illustrating an example of the operation of a transmit/receive control portion;

FIG. 5 shows an example in which addresses in system memory are stored in a storage area as transfer request information;

FIG. 6 is a flowchart illustrating an example of the operation of a data transfer portion in accordance with a first embodiment of the present invention;

FIG. 7 shows an example in which addresses in system memory and effective endpoint information are stored in a storage area as transfer request information; and

FIG. 8 is a flowchart illustrating an example of the operation of a data transfer portion in accordance with a second embodiment of the present invention.

### DETAILED DESCRIPTION OF THE PREFERRED EMBODIMENTS

The invention will now be described herein with reference to illustrative embodiments. Those skilled in the art will recognize that many alternative embodiments can be accomplished using the teachings of the present invention and that the invention is not limited to the embodiments illustrated for explanatory purposes.

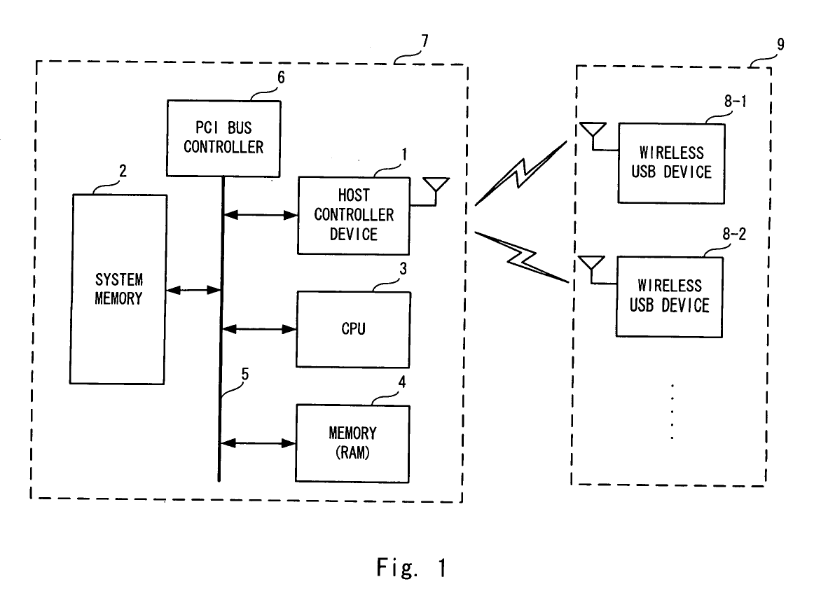

Embodiments of the present invention are explained hereinafter with reference to the drawings. In the following descriptions and the drawings, some nonessential parts are omitted or simplified as appropriate in order to clarify the explanations. In the drawings, the same signs are assigned to identical or equivalent components and components having identical or equivalent functions, and explanations of them are omitted as appropriate. Furthermore, there are several identical components in the present specification. Therefore, when these components need to be differentiated from each other, the sign “−n (n is integer greater than 0)” is added to the original sign to differentiate one from others. For example, FIG. 1 shows a plurality of wireless USB devices 8-1, 8-2, . . . , 8-j. For example, when explanation is made with reference to FIG. 1, the term “wireless USB device 8” means any one or ones of wireless USB devices 8-1, 8-2, . . . , and the term “wireless USB device 8-1 (or wireless USB device 8-2 or the like)” is used to differentiate the wireless USB device 8-1 (or wireless USB device 8-2 or the like) from other wireless USB devices.

Furthermore, one example of a system to carry out wireless USB communication is explained in the following explanations. However, the present invention is also applicable to wired USB systems.

FIG. 1 shows an example of the structure of a system to carry out wireless USB communication in accordance with one aspect of the present invention. On the host side, a host device 7, which includes a host controller device 1, a system memory 2, a CPU (Central Processing Unit) 3, and a memory 4, all of which are connected to a PCI (Peripheral Component Interconnect) bus 5, and is controlled by a PCI bus controller 6, is illustrated as an example. Only the components essential to the present invention are illustrated for the host device 7, and other nonessential components are omitted in FIG. 1. Furthermore, on the device side, wireless USB devices 8 are illustrated as an example of a slave device 9. Incidentally, the only requirement for the slave device 9 is that the slave device 9 should have at least one wireless USB devices 8 within it. Furthermore, the slave device 9 is not limited to the wireless USB devices 8. Instead, it may be a relay device that relays data transfer between the host controller device 1 that carries out wireless communication and a wired USB device.

In the following explanations, the host controller device 1 is explained with an assumption that the host controller device 1 is a microcomputer installed in the host device 7. The host controller device 1 is connected to the PCI bus 5, and controlled by a driver function installed in the host device 7. The driver function may be, for example, realized by a software program, and the CPU 3 may execute corresponding instructions to realize the driver function loaded in the memory 4. The memory 4 may be, for example, a RAM (Random Access Memory).

The host device 7, upon connection to the slave devices 9, acquires endpoint information identifying each slave device 9 (e.g., wireless USB devices 8) from each of those slave devices 9 through the host controller device 1, and stores them in the system memory 2.

When data transfer is to be requested between the host device 7 and the slave device 9, endpoint information is created in the system memory 2 and the host controller device 1 transfers data based on that endpoint information. Endpoint information includes endpoint information that requests data transfer (which is called “effective endpoint information” as appropriate) and endpoint information that does not contribute to data transfer (which is called “ineffective endpoint information” as appropriate).

In each of the following embodiments, a technique that enables the host controller device 1 to refer to effective endpoint information with efficiency is explained.

### First Embodiment

As a first embodiment, a case in which addresses in system memory 2 where effective endpoint information is held are stored in a storage area within the host controller is explained hereinafter.

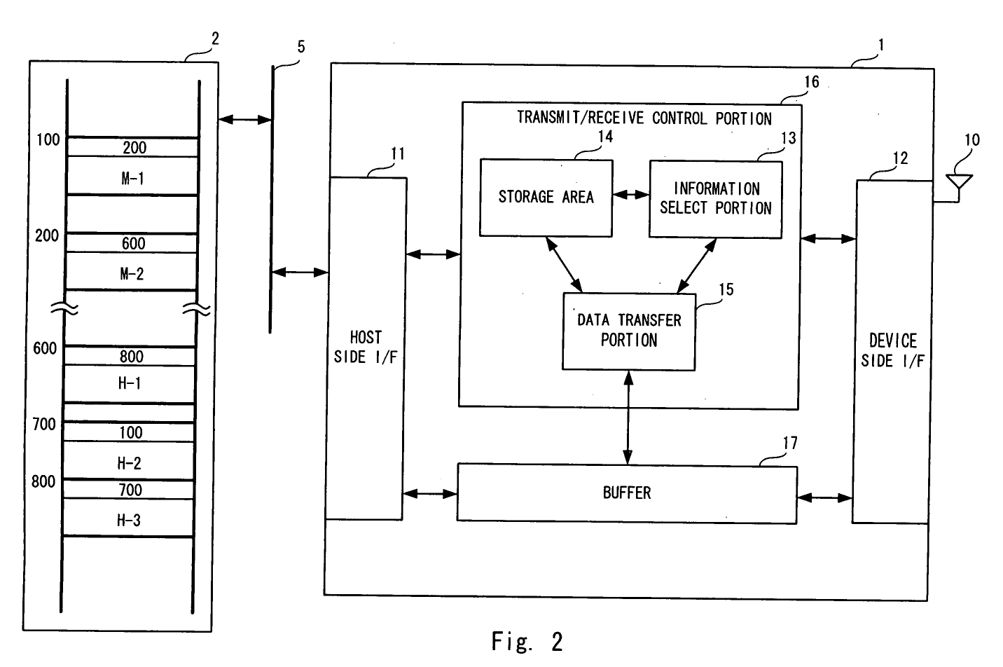

FIG. 2 is a block diagram showing an example of the structure of a host controller device in accordance with one embodiment of the present invention. Furthermore, FIG. 2 also shows an example of the system memory 2. The host controller device 1 includes a host side interface (which is called “host side I/F” hereinafter) 11, a device side interface (which is called “device side I/F” hereinafter) 12, a transmit/receive control portion 16, and a buffer 17.

The host side I/F 11 transmits and receives data to and from the system memory 2 and other components within the host device 7 through the PCI bus 5. The device side I/F 12 transmits and receives data to and from the slave device 9 through wireless communication.

The transmit/receive control portion 16 controls data transfer between the host device 7 and the slave device 9. Specifically, FIG. 2 illustrates an example that realizes the transmit/receive control portion 16 by dividing it into three functions, i.e., an information select portion 13, a storage area 14, and a data transfer portion 15. The information select portion 13 selects plural endpoint information requesting data transfer by analyzing a plurality of endpoint information held in the system memory 2.

The storage area 14 stores addresses in system memory that are selected by the information select portion 13. The storage area 14 assigns sequential numbers to the addresses (for example, in the order of record number), and stores them. The order in which the addresses are stored is the same as the order in which several data transfers are carried out repeatedly. As an example, the storage area 14 is used in the following manner. Since the storage area 14 is comprised of a memory, the addresses are stored in the storage area 14, for example, in increasing order of address values. Furthermore, in the case where several data transfers are carried out repeatedly, the counter that is used to indicate the address of the currently-referred storage area 14 is reset to zero and the address in system memory 2 that is currently indicated by the counter is firstly processed. Then, after finishing that process, the counter is incremented and the next address in system memory is acquired. A flag is used to determine whether data transfer requested by the endpoint information located at the address in system memory 2 held in the storage area 14 is completed or not. The flag is stored in the storage area 14 in combination with that address in system memory 2. For example, the flag is set to “1” when it is initially stored. Furthermore, the amount of data that is transferred with single endpoint information is not necessarily limited to a fixed amount. For example, when the sizes of files to be copied are different with each other, the amounts of data to be transferred are also different. When processes are carried out in sequence, the address in system memory 2 indicating endpoint information for which the whole data transfer was completed needs to be eliminated from the set of target addresses to be processed, and therefore the flag that is stored in combination with that address is set to “0”. The counter is successively incremented, and then reset to zero when it reaches the final value. The address in system memory 2 for which the corresponding flag was already set to “0” is not handled as the target address for data transfer, and therefore the counter is just incremented and the process proceeds to the next address.

The data transfer portion 15 carries out data transfer based on at least one address in system memory 2 stored in the storage area 14. The data transfer portion 15 refers to endpoint information by using the plural addresses in system memory 2, and carries out the requested data transfers in a repetitive manner based on the plural endpoint information. The data transfer portion 15 carries out at least one data transfer based on endpoint information that is referred by using one address in system memory 2, and repeats data transfer until the amount of transferred data reaches the data amount of the data transfer requested by the endpoint information corresponding to each of the addresses in system memory 2. The data transfer portion 15 carries out a single data transfer within a specific time period that is allocated for the data transfer of its own host controller device 1 (within its own transfer time period). Specifically, the data transfer portion 15 allocates data to be transferred to packets, and repeats the transfer of the packet within the allocated time period. Furthermore, the data transfer portion 15 uses the buffer 17 to temporarily store data to be transferred.

The buffer 17 is a storage area to temporarily store the data that is transferred between the host device 7 and the slave device 9.

FIG. 2 shows a state in which five endpoint information are held in the system memory 2. The numerical values on the left side are addresses, and endpoint information is shown on the right side of the addresses. As the endpoint information, endpoint information (M-1, M-2, . . , H-1-H-3) notified from the slave device 9 are held in the system memory 2 in combination with the addresses of the areas where the endpoint information that are read out subsequent to the current endpoint information are located (which are called “next addresses” hereinafter). Furthermore, the endpoint information that contributes to data transfer also includes the addresses in system memory 2 at which data to be transferred is held. An assumption is made in FIG. 2 that the endpoint information M-1 and M-2 are notified from the wireless USB device 8-1, and the endpoint information H-1-H-3 are notified from the wireless USB device 8-2. Although endpoint information in a circular configuration is illustrated in FIG. 2 as an example, the present invention is also applicable to endpoint information in a linear configuration. In such a case, the last endpoint information has the termination information, so that it can determine that that endpoint information is the last endpoint information.

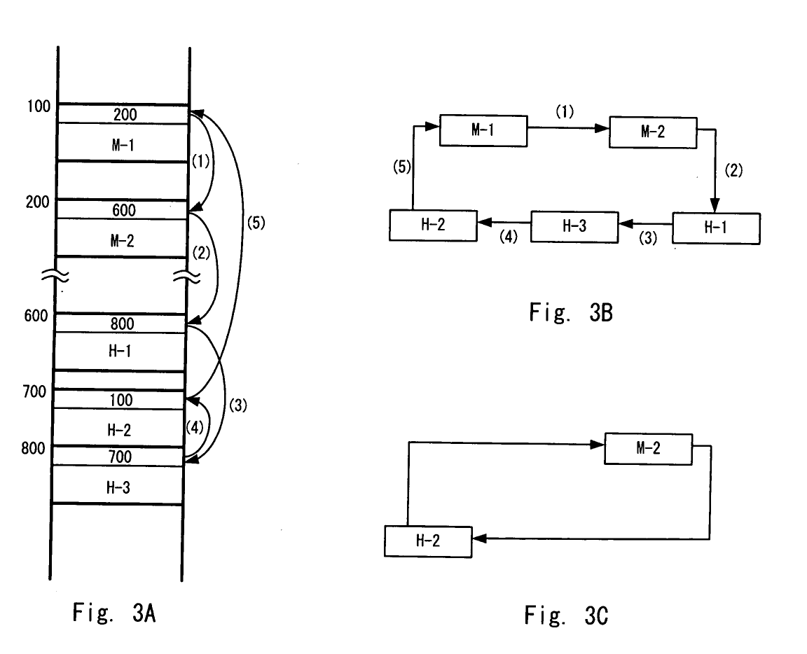

Next, the order in which the host controller device 1 accesses to endpoint information held in the system memory 2 is explained hereinafter. FIGS. 3A-3C are figures for illustrating a read-out process in which endpoint information is read out successively in a circular manner. In particular, FIG. 3A shows one example of endpoint information held in a system memory, FIG. 3B shows the order in which endpoint information is read out, and FIG. 3C shows a state in which only the effective endpoint information is read out. In USBs, the address of endpoint information that is to be read out first is held in the list address. To start data transfer, the host controller device 1 firstly reads out endpoint information located at the address held in the list address, and then reads out endpoint information located at the address that is held with that read-out endpoint information. Assume that an address “100” is held in the list address in the following explanation.

Specifically, the host controller device 1 reads out endpoint information in the order (1)-(5) illustrated in FIG. 3A. Therefore, the host controller device 1 analyzes the endpoint information in the order of M-1, M-2, H-1, H-3, H-2 as shown in FIG. 3B. Assume also that only M-2 and H-2 are effective endpoint information, and the others are ineffective endpoint information in the following explanation. In such a case, once the host controller device 1 analyzes all the effective endpoint information, it would be desirable that the host controller device 1 reads out endpoint information in the loop shown in FIG. 3C.

Therefore, the transmit/receive control portion 16 in accordance with this embodiment, after analyzing endpoint information stored in the system memory 2, stores the addresses in system memory 2 that indicate the effective endpoint information requesting data transfer in the storage area 14 within the host controller device 1. Then, the transmit/receive control portion 16 accesses to the system memory 2 based on these stored addresses in system memory 2. Therefore, it no longer needs to read out the ineffective endpoint information for every data transfer. In this manner, the number of accesses to the system memory 2 by the host controller device 1, especially the number of the read-out of ineffective endpoint information can be reduced. This effect is produced regardless of presence of addresses in system memory 2 that are stored in the storage area 14. The absence of addressed in the system memory 2 in the storage area 14 indicates that the host controller device 1 does not need to carry out any data transfer. Furthermore, when at least one address in system memory 2 is stored in the storage area 14, the host controller device 1 can carry out the data transfer without accessing to the endpoint information that does not contribute to data transfer.

Next, the operation of the transmit/receive control portion 16 is explained hereinafter. The transmit/receive control portion 16 of the host controller device 1 operates, in general, in the following manner. (1) Store addresses in system memory 2 identifying effective endpoint information in the storage area 14, (2) Data transfer, (3) Handshake reception, and (4) Update endpoint information stored in the system memory 2. The transmit/receive control portion 16 repeats the steps (2)-(4) until all effective endpoint information disappears. An example of the operation is explained based on a concrete flowchart. In this example, a case in which the item (1) is carried out by the information select portion 13, and the items (2)-(4) are carried out by the data transfer portion 15 is explained.

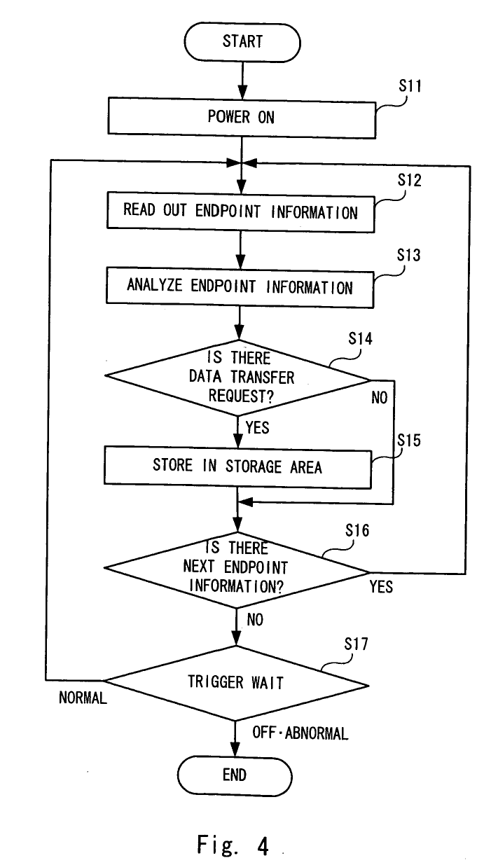

FIG. 4 is a flowchart illustrating an example of the operation of an information select portion. The information select portion 13, upon powering on of the host controller device 1 (S11), reads out endpoint information from the system memory 2 (S12). When the information select portion 13 reads out endpoint information for the first time, it reads out the endpoint information located at the address that is held in the list address. Then, the information select portion 13 analyzes the read-out endpoint information to determine whether the endpoint information is requesting data transfer or not (S13). If the endpoint information is effective endpoint information (Yes at S14), the information select portion 13 stores the address in system memory 2 in the storage area 14 (S15). If it is not effective endpoint information (No at S14), the information select portion 13 does not carry out the process at the step S15.

Then, if the next address that is held with that read-out endpoint information does not match with the address held in the list address, the information select portion 13 determines that there is next endpoint information (Yes at S16) and repeats the processes from the step S12. At this point, the information select portion 13 reads out endpoint information located at the next address from the system memory 2 (S12). The following processes are carried out in a similar manner to the above-described processes. On the other hand, if the next address matches with the address held in the list address, the information select portion 13 determines that it has analyzed all endpoint information (No at S16) and enters into a wait state (S17). When endpoint information held in the system memory 2 is updated, the information select portion 13 receives an update notice (Notification at S17) and repeats the processes from the step S12. Specifically, the information select portion 13 receives the update notice (PCI register write) from the driver software running on the host device 7. Furthermore, the information select portion 13 terminates the operation upon powering off of the host controller device 1, notification of the occurrence of an abnormal operation, or occurrence of a similar situation (OFF•Abnormal at S17).

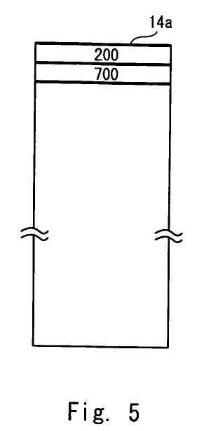

In this manner, addresses in system memory 2 are stored in the storage area 14. For example, FIG. 5 shows an example of results of endpoint information analyzed and stored by the information select portion 13 based on the endpoint information shown in FIG. 3. The information select portion 13 stores the same number of addresses as the number of endpoint information requesting data transfer, for example, in the manner illustrated as the storage area 14a. The data transfer portion 15 carries out data transfer based on the addresses in system memory 2 that are stored in the storage area 14.

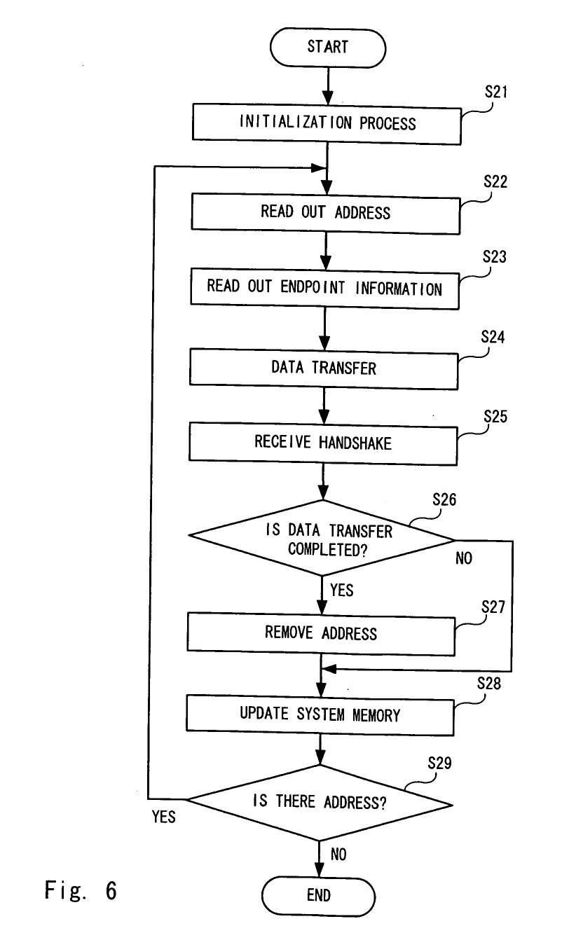

Next, the operation of the data transfer portion 15 is explained hereinafter. FIG. 6 is a flowchart illustrating an example of the operation of a data transfer portion. The data transfer portion 15, upon reception of the notification that the information select portion 13 is requesting data transfer, starts an initialization process (S21). For example, the initialization process may include the initialization of a counter. Then, the data transfer portion 15 reads out the addresses stored in the storage area 14 in sequence (S22). The data transfer portion 15 reads out endpoint information located in the system memory 2 from the system memory 2 based on the read-out addresses (S23). The order in which the endpoint information is read out is determined, for example, by specifying the ordinal numbers of the addresses in system memory 2 by a counter or the like. Then, the data transfer portion 15 carries out data transfer requested by the endpoint information (S24). At this point, the data transfer portion 15, for example, carries out data transfer corresponding to one address in system memory 2 within a predetermined time period (its own transfer time period). Then, if the data transfer requested by the endpoint information is not completed in that time period, the data transfer portion 15 transfers the remaining data in the next data transfer.

The data transfer portion 15 receives a handshake for the data transfer (S25), and determines whether the data transfer requested by that endpoint information is completed or not based on the result of the received handshake (S26). If the data transfer is completed (Yes at S26), the data transfer portion 15 removes the address of the endpoint information from the storage area 14 (S27). On the other hand, if the data transfer is not completed (No at S26), the data transfer portion 15 does not carry out the process at the step S27. Then, the data transfer portion 15 reflects the current data transfer to the endpoint information stored within the system memory 2 (S28). The data transfer portion 15 determines whether addresses are stored in the storage area 14 or not. Then, if addresses are stored in the storage area 14 (Yes at S29), the data transfer portion 15 repeats the processes from the step S31. If no address is stored in the storage area 14 (No at S29), the data transfer portion 15 terminates the process. If the data transfer is not completed, the system memory 2 is updated as an intermediate step. When the counter is advanced and the same address is designated again, the remaining data transfer is restarted.

Assuming, for example, a case where there are effective endpoint information like the one shown in FIG. 3C in the operational example shown in FIG. 6, the storage area 14 stores addresses in system memory 2 corresponding to M-2 and H-2 endpoint information. The data transfer portion 15 repeatedly reads out the M-2 and H-2 endpoint information in sequence from the system memory 2 at the step S23. Furthermore, data transfer corresponding to either the M-2 or H-2 endpoint information is completed, the other endpoint information is read out repeatedly.

The number of accesses to the system memory 2 is examined in the following explanations. Firstly, the accesses to the system memory 2 are carried out in such a manner that the same number of read-out operations of endpoint information from the system memory 2 as the number of all the endpoint information are carried out so that the information select portion 13 can select effective endpoint information. However, after those operations, only the effective endpoint information needs to be accessed. Therefore, once the host controller device 1 selects effective endpoint information, it no longer needs to read out all endpoint information held in the system memory 2 in sequence, and therefore the number of accesses to the system memory 2 can be reduced.

As have been explained so far, this embodiment in accordance with the present invention can reduce the number of the read-out of ineffective endpoint information by selecting effective endpoint information and storing the addresses in system memory 2 at which the effective endpoint information is stored in the storage area 14. As a result, the data transfer efficiency can be improved. Furthermore, since this embodiment requires less amount of memory to store addresses in system memory 2 than that in the case where endpoint information itself is stored, it can be applied even to the case where the amount of memory allocated to the host controller device is limited. Therefore, it is expected that the present invention may be applied to a wider range of applications. Furthermore, the present invention can be easily applied even to the case where the number or amount of data transfer requested from the slave device 9 is large, or to the case where the number of the slave devices 9 is large.

Incidentally, although addresses in system memory 2 are stored in the storage area 14 in the above-described embodiment, the endpoint information itself may be temporarily stored in the storage area 14. In this manner, the data transfer that is requested by that effective endpoint information can be completed within the host controller device 1, and therefore the number of read-out operations of effective endpoint information from the system memory 2 can be reduced. Furthermore, the number of accesses to the system memory 2 can be also reduced by storing only the portion of effective endpoint information that is related to data transfer in the storage area 14. By storing only the portion of effective endpoint information, it can further reduce the required amount of memory compared to the case where entire effective endpoint information is stored.

### Second Embodiment

As a second embodiment, a case in which endpoint information that contribute to data transfer is selected from a plurality of endpoint information located in the system memory and the selected endpoint information is stored in the storage area 14 within the host controller device 1 as effective endpoint information is explained hereinafter. The host controller device 1 has a structure similar to that shown in FIG. 2. In the following descriptions, the operational differences of the transmit/receive control portion 16 from those of the first embodiment are mainly explained.

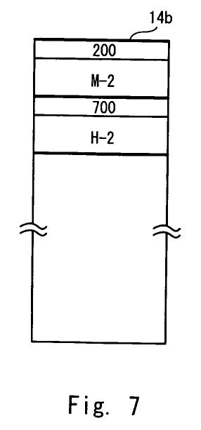

The information select portion 13 operates, in general, along the flowchart shown in FIG. 4, except that it stores effective endpoint information itself in addition to its corresponding addresses in system memory 2 in the step S15. The other operations are the same as those of the first embodiment. For example, FIG. 7 shows the results of the analysis and storage the endpoint information shown in FIG. 3 by the information select portion 13. In contrast to FIG. 5, an example of a storage area storing addresses in system memory 2 at which corresponding endpoint information is located in combination with the endpoint information itself is illustrated as the storage area 14b.

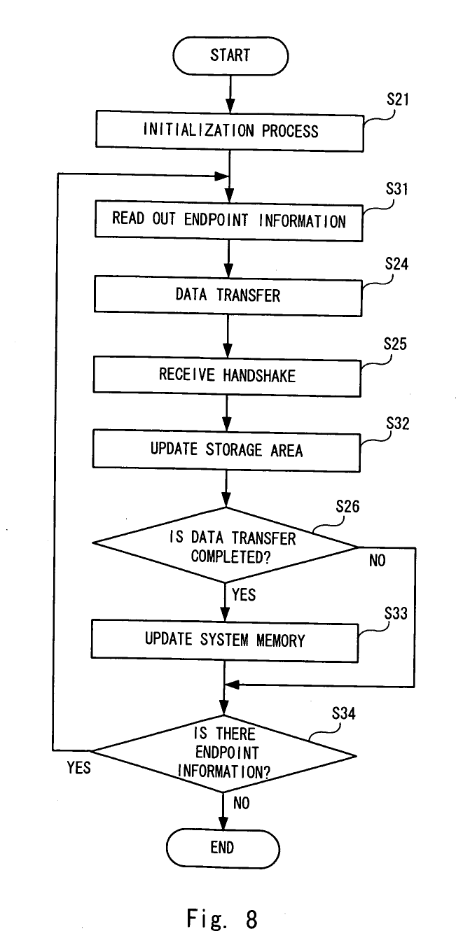

Next, the operation of the data transfer portion 15 is explained hereinafter. FIG. 8 is a flowchart illustrating an example of the operation of a data transfer portion in accordance with the second embodiment. In FIG. 8, the operations having the same step numbers as those in FIG. 6 are the same operations as those in FIG. 6. Firstly, the data transfer portion 15 carries out an initialization process (S21). Then, the data transfer portion 15 reads out endpoint information stored in the storage area 14 in sequence (S31). The order in which the endpoint information is read out is determined, for example, by specifying the ordinal numbers of the endpoint information by a counter or the like. Then, the data transfer portion 15 carries out data transfer requested by the endpoint information (S24). The amount that is transferred in a single transfer is the same as that of the first embodiment.

After the handshake (S25), the data transfer portion 15 updates the endpoint information stored in the storage area 14 (S32). For example, a process in which information relating to data that is already transferred with handshake is removed from the endpoint information and information relating to data that needs to be re-transferred is left unremoved, or similar processes may be carried out. Furthermore, if data transfer requested by endpoint information is already completed, that endpoint information is removed from the storage area 14. Furthermore, if the data transfer requested by endpoint information is already completed (Yes at S26), the data transfer portion 15 updates that endpoint information located in the system memory 2 (S33). The data transfer portion 15 updates the endpoint information by using the address in system memory 2 that is stored in the storage area 14. If the data transfer is not completed (No at S26), the data transfer portion 15 does not carry out the process at the step S33. Next, if endpoint information is stored in the storage area 14 (Yes at S34), the data transfer portion 15 repeats the processes from the step S31. If no endpoint information is stored in the storage area 14 (No at S34), the data transfer portion 15 terminates the process.

As have been explained so far, this embodiment in accordance with the present invention can reduce the number of the read-out of ineffective endpoint information by selecting effective endpoint information and storing them in the storage area 14. Furthermore, since effective endpoint information is stored in the storage area 14, the data transfer requested by that effective endpoint information can be completed within the host controller device 1, and therefore the number of the read-out operations of effective endpoint information from the system memory 2 can be reduced. In this manner, the data transfer efficiency can be improved.

As have been explained so far, at least one of preferred embodiments in accordance with the present invention can reduce the number of accesses to ineffective endpoint information that does not contribute to data transfer by storing addresses in system memory 2 that identify effective endpoint information requesting data transfer from among endpoint information stored in the system memory 2 in the storage area 14 within the host controller device 1. By storing effective endpoint information in the storage area within the host controller device 1, it can further reduce the number of accesses to the effective endpoint information located in the system memory 2. With these features, improvement in the data transfer efficiency can be expected.

Incidentally, the example in each of the above described embodiments in which transfer request information is stored in a storage area should be considered to be merely one example, and the present invention is not limited to such examples. Furthermore, the concrete examples of the information identifying effective endpoint information that is stored in the storage area 14 as the transfer request information should be also considered to be merely examples. Instead, any information that reduces the number of accesses to endpoint information located in the system memory 2 can be used in place of or in addition to the above-described information. Furthermore, such information may be used in combination with each other.

It is apparent that the present invention is not limited to the above embodiments, but may be modified and changed without departing from the scope and spirit of the invention.

What is claimed is:

1. A host controller device installed in a host device having a system memory to communicate with a USB device comprising:
an information select portion to select endpoint information requesting data transfer by analyzing a plurality of endpoint information held in the system memory;
a storage area to store at least one address in system memory identifying the endpoint information selected by the information select portion; and
a data transfer portion to carry out the requested data transfer based on the endpoint information identified by the at least one address in system memory stored in the storage area.

2. The host controller device in accordance with claim 1, wherein the data transfer portion continues data transfer until the amount of transferred data reaches the data amount of the requested data transfer or the transfer time reaches its own allocated transfer time period, and repeats data transfer until the data transfer requested by the endpoint information identified by the address in system memory that is stored in the storage area is completed.

3. The host controller device in accordance with Claim 2, wherein
the storage area stores plural addresses,in system memory; and
the data transfer portion refers to plural endpoint information identified by the plural addresses in system memory and repeats data transfer until the amount of transferred data reaches the data amount of the data transfer requested by the plural endpoint information based on the plural endpoint information.

4. The host controller device in accordance with claim 1, wherein the information select portion is notified that endpoint information held in the system memory is changed, analyzes endpoint information held in the system memory in sequence based on the notification, and updates addresses in system memory that is stored in the storage area.

5. The host controller device in accordance with claim 2, wherein the information select portion is notified that endpoint information held in the system memory is changed, analyzes endpoint information held in the system memory in sequence based on the notification, and updates addresses in system memory that is stored in the storage area.

6. The host controller device in accordance with Claim 3, wherein the information select portion is notified that endpoint information held in the system memory is changed, analyzes endpoint information held in the system memory in sequence based on the notification, and updates addresses in system memory that is stored in the storage area.

7. The host controller device in accordance with claim 1, wherein data transfer portion updates endpoint information held in the system memory upon termination of data transfer in its own allocated transfer time period.

8. The host controller device in accordance with claim 2, wherein data transfer portion updates endpoint information held in the system memory upon termination of data transfer in its own allocated transfer time period.

9. The host controller device in accordance with claim 3, wherein data transfer portion updates endpoint information held in the system memory upon termination of data transfer in its own allocated transfer time period.

10. The host controller device in accordance with claim 4, wherein data transfer portion updates endpoint information held in the system memory upon termination of data transfer in its own allocated transfer time period.

11. The host controller device in accordance with claim 1, wherein the storage area stores the selected endpoint information in addition to the addresses in the system memory.

12. The host controller device in accordance with claim 2, wherein the storage area stores the selected endpoint information in addition to the addresses in the system memory.

13. The host controller device in accordance with claim 3, wherein the storage area stores the selected endpoint information in addition to the addresses in the system memory.

14. The host controller device in accordance with claim 4, wherein the storage area stores the selected endpoint information in addition to the addresses in the system memory.

15. The host controller device in accordance with claim 1, wherein data transfer portion removes addresses in system memory from the storage area, the addresses corresponding to endpoint information for which data transfer is completed.

16. The host controller device in accordance with claim 2, wherein data transfer portion removes addresses in system memory from the storage area, the addresses corresponding to endpoint information for which data transfer is completed.

17. The host controller device in accordance with claim 3, wherein data transfer portion removes addresses in system memory from the storage area, the addresses corresponding to endpoint information for which data transfer is completed.

18. The host controller device in accordance with claim 1, wherein the USB device is a wireless USB device.

19. A data transfer control method of a host controller device installed in a host device having a system memory to communicate with a USB device comprising:
reading out a plurality of endpoint information held in the system memory one by one;
selecting endpoint information requesting data transfer by analyzing the read-out endpoint information;
storing an address in system memory identifying the selected endpoint information in a storage area;
repeating the storing step for each of the plurality of endpoint information held in the system memory; and
carrying out data transfer based on at least one address in system memory stored in the storage area.
